(19) United States
(12) Patent Application Publication
(10) Pub. No.: US 2026/0255061 A1
(43) Pub. Date: Aug. 27, 2026

(54) IMAGE ACQUISITION METHOD AND APPARATUS, DEVICE, MEDIUM, AND PROGRAM PRODUCT

(71) Applicant: Beijing Zitiao Network Technology Co., Ltd., Beijing (CN)

(72) Inventors: Weitao ZHONG, Beijing (CN); Yinjian MA, Beijing (CN); Guocheng YANG, Beijing (CN)

(21) Appl. No.: 19/541,087

(22) Filed: Feb. 16, 2026

(30) Foreign Application Priority Data
Feb. 21, 2025 (CN) 202510200483.8

(51) Int. Cl. H04N 23/68; G06T 7/70; G06T 7/73; G06T 7/80; H04N 23/81

(52) U.S. Cl. CPC H04N 23/683; G06T 7/70; G06T 7/73; G06T 7/80; H04N 23/81

(57) ABSTRACT

An image acquisition method and apparatus, a device, a medium, and a program product are disclosed. The image acquisition method includes: displaying an angle auxiliary frame in an image acquisition page of an image acquisition device in response to an image acquisition operation based on a reference image; adjusting a pose of the angle auxiliary frame in response to a rotation of the image acquisition device, and displaying first prompt information in a region other than a display region of the angle auxiliary frame in the image acquisition page, where adjusting the pose of the angle auxiliary frame includes adjusting at least one of a position or a posture of the angle auxiliary frame; and acquiring an image within a field of view of the image acquisition device in response to an operation of determining to acquire the image.

### CROSS-REFERENCE TO RELATED APPLICATION

This application claims priority to and benefits of Chinese Patent Application No. 202510200483.8, which is filed on Feb. 21, 2025. All the aforementioned patent applications are hereby incorporated by reference in their entireties.

### TECHNICAL FIELD

The present disclosure relates to an image acquisition method, an image acquisition apparatus, an electronic device, a computer-readable storage medium, and a computer program product.

### BACKGROUND

With the development of electronic technologies, using an image acquisition device to acquire images has become a main way of recording information in daily work and life. In an image acquisition process, the aesthetics of an acquired image may be improved by adjusting the posture of the image acquisition device. However, the adjustment of the posture of the image acquisition device usually relies on experience and skills, and has a high learning cost, which is not conducive to stimulating interest in image acquisition.

### SUMMARY

The Summary section is provided in order to introduce ideas in a brief form, and these ideas will be described in detail in the following Detailed Description section. The Summary section is not intended to identify key features or necessary features of the claimed technical solutions, nor is it intended to limit the scope of the claimed technical solutions.

At least one embodiment of the present disclosure provides an image acquisition method, including: displaying an angle auxiliary frame in an image acquisition page of an image acquisition device in response to an image acquisition operation based on a reference image; adjusting a pose of the angle auxiliary frame in response to a rotation of the image acquisition device, and displaying first prompt information in a region other than a display region of the angle auxiliary frame in the image acquisition page; where adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image; and acquiring an image within a field of view of the image acquisition device in response to an operation of determining to acquire the image.

At least another embodiment of the present disclosure provides an image acquisition apparatus, including: a display module, configured to display an angle auxiliary frame in an image acquisition page of an image acquisition device in response to an image acquisition operation based on a reference image; and a display adjustment module, configured to adjust a pose of the angle auxiliary frame in response to a rotation of the image acquisition device, and display first prompt information in a region other than a display region of the angle auxiliary frame in the image acquisition page; where adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image; and an image acquisition module, configured to acquire an image within a field of view of the image acquisition device in response to an operation of determining to acquire the image.

At least yet another embodiment of the present disclosure provides an electronic device, including: a processing apparatus; and a storage apparatus, including one or more computer program instructions; where the one or more computer program instructions, when executed by the processing apparatus, implement the image acquisition method provided by at least one embodiment of the present disclosure.

At least still another embodiment of the present disclosure provides a non-transitory computer-readable storage medium, non-transiently storing computer-readable instructions, where the computer-readable instructions, when executed by a processor, implement the image acquisition method provided by at least one embodiment of the present disclosure.

At least a further embodiment of the present disclosure provides a computer program product, including a computer program/instructions, which, when running on a computer, causes the computer to execute the image acquisition method provided by at least one embodiment of the present disclosure.

### BRIEF DESCRIPTION OF DRAWINGS

The above and other features, advantages, and aspects of the embodiments of the present disclosure will become more apparent in combination with the drawings and with reference to the following “Detailed Description” part. Throughout the drawings, the same or similar reference numbers refer to the same or similar elements. It should be understood that the drawings are schematic, and that parts and elements are not necessarily drawn to scale.

FIG. 1 is a schematic diagram of an application scenario of an image acquisition method and an apparatus provided by at least one embodiment of the present disclosure;

FIG. 2 is a schematic flowchart of an image acquisition method provided by at least one embodiment of the present disclosure;

FIG. 3A is a schematic diagram of an image acquisition page provided by at least one embodiment of the present disclosure;

FIG. 3B is a schematic diagram of an image acquisition page provided by at least another embodiment of the present disclosure;

FIG. 4 is a schematic diagram of an effect of adjusting a pose of an angle auxiliary frame provided by at least one embodiment of the present disclosure;

FIG. 5 is a schematic diagram of an effect of adjusting a pose of an angle auxiliary frame provided by at least another embodiment of the present disclosure;

FIG. 6 is a schematic diagram of a change in a display state of an angle auxiliary frame in a process of an image acquisition device rotating to a reference posture provided by at least one embodiment of the present disclosure;

FIG. 7 is a schematic diagram of a change in a display state of an angle auxiliary frame in a process of an image acquisition device rotating to a reference posture provided by at least another embodiment of the present disclosure;

FIG. 8 is a schematic diagram of an image acquisition page in a case where an image acquisition device rotates to a reference shooting angle provided by at least one embodiment of the present disclosure;

FIG. 9 is a schematic diagram of a change in a display state of an angle auxiliary frame in a process of an image acquisition device rotating in a direction away from a reference posture provided by at least one embodiment of the present disclosure;

FIG. 10 is a schematic block diagram of an image acquisition apparatus provided by at least one embodiment of the present disclosure; and

FIG. 11 is a schematic structural diagram of an electronic device suitable for implementing an embodiment of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be interpreted as being limited to the embodiments set forth herein; on the contrary, these embodiments are provided for a more thorough and complete understanding of the present disclosure. It should be understood that the drawings and embodiments of the present disclosure are only used for exemplary purposes, and are not used to limit the protection scope of the present disclosure.

It should be understood that steps described in method implementations of the present disclosure may be performed in different orders and/or in parallel. In addition, the method implementations may include additional steps and/or omit the execution of some shown steps. The scope of the present disclosure is not limited in this regard.

The term “include/comprise” and its variants used herein are open-ended inclusions, that is, “include/comprise but not limited to”. The term “based on” is “at least partially based on”. The term “one embodiment” means “at least one embodiment”; the term “another embodiment” means “at least one other embodiment”; the term “some embodiments” means “at least some embodiments”. Relevant definitions of other terms will be given in the following description.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that modifications of “one” and “multiple” mentioned in the present disclosure are illustrative and not restrictive, and those skilled in the art should understand that unless otherwise clearly indicated in the context, they should be understood as “one or more”.

The names of messages or information exchanged between multiple apparatuses in the implementations of the present disclosure are only used for illustrative purposes, and are not used to limit the scope of these messages or information.

With the development of electronic technologies, using an image acquisition device to acquire images has become one of the main ways of recording information in daily work and life. In an image acquisition process, a shooting angle may be adjusted by adjusting a posture of the image acquisition device, for example, the shooting angle may be adjusted by adjusting a horizontal angle and/or a pitch angle of the image acquisition device, so that a captured image is more artistic and more in line with actual needs. However, the posture adjustment of the image acquisition device needs to rely on shooting experience and skills. If one wants to capture more artistic images, one often needs to learn shooting skills and constantly practice shooting. This will undoubtedly reduce the user's shooting interest, which is not conducive to the promotion of the image acquisition device or shooting applications.

For example, in order to stimulate shooting interest, a user may be provided with a follow shooting (challenge) function. For example, the user may take a highly artistic image as a reference image and adjust the posture of the image acquisition device by imitating the reference image, in order to acquire an image with a shooting effect similar to that of the reference image. However, even with the reference image, it is often difficult for the user to accurately adjust the posture of the image acquisition device, and the shooting effect of the acquired image is significantly worse than that of the reference image.

In order to at least partially solve these technical problems, at least one embodiment of the present disclosure provides an image acquisition method. The method includes: displaying an angle auxiliary frame in an image acquisition page of an image acquisition device in response to an image acquisition operation based on a reference image; adjusting a pose of the angle auxiliary frame in response to a rotation of the image acquisition device, and displaying first prompt information in a region other than a display region of the angle auxiliary frame in the image acquisition page; and acquiring an image within a field of view of the image acquisition device in response to an operation of determining to acquire the image. Adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image.

Based on the image acquisition method provided by at least one embodiment of the present disclosure, at least one embodiment of the present disclosure also provides an image acquisition apparatus, an electronic device, a computer-readable storage medium, and a computer program product.

The image acquisition method provided by at least one embodiment of the present disclosure displays the angle auxiliary frame in the image acquisition page in an image acquisition process based on the reference image, and adjusts the pose of the angle auxiliary frame according to the rotation of the image acquisition device, so that a user may more explicitly perceive a current posture of the image acquisition device. The first prompt information is displayed in response to the rotation of the image acquisition device, so that the rotation direction of rotating to the reference shooting angle indicated by the reference image may be explicitly prompted to the user. This is favorable for improving the precision of the user to adjust the posture of the image acquisition device based on the reference image, and for acquiring an image with a shooting effect approaching that of the reference image, thereby improving an image acquisition experience.

The embodiments of the present disclosure and some of their examples are described in detail below with reference to the drawings.

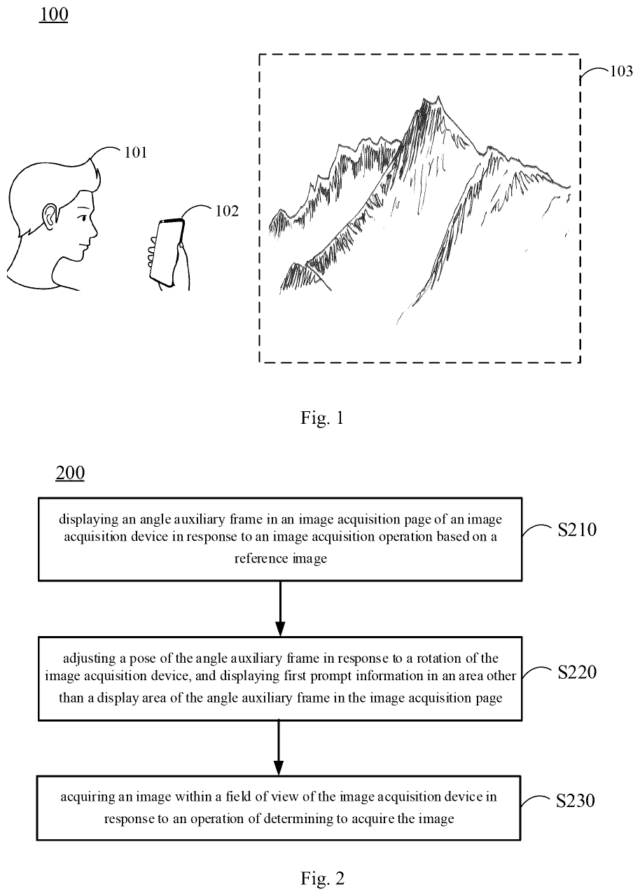

FIG. 1 is a schematic diagram of an application scenario of an image acquisition method and an apparatus provided by at least one embodiment of the present disclosure.

As shown in FIG. 1, the application scenario 100 of this embodiment includes a user 101, an image acquisition device 102, and a scenery 103. The user 101 may hold the image acquisition device 102 to acquire an image within a field of view of the image acquisition device 102, and the acquired image may include the scenery 103, for example.

The image acquisition device 102 may be any device provided with a camera, such as a mobile phone, a digital camera, a video camera, a tablet computer, or a smart wearable device.

For example, the image acquisition device 102 may be installed with an application that may call the camera to provide a photographing function. The user 101 may select a reference image by operating the application, for example, and adjust the posture of the image acquisition device 102 based on the reference image, so as to acquire a more artistic image.

For example, the application installed on the image acquisition device 102 may provide a follow shooting function.

Exemplarily, an image acquisition page of the application may provide an entrance to the follow shooting function. For example, the application may provide multiple images that may be used as a reference to the user 101 in response to a click operation of the user 101 on the entrance, and then take a selected image as a reference image in response to a selection operation of the user 101 on any of the multiple images. Alternatively, for example, the application may provide an import box for importing a reference image to the user 101 in response to the click operation of the user 101 on the entrance, and the user 101 may select, by operating the import box, an image locally stored in the image acquisition device 102 or stored in other devices communicatively connected to the image acquisition device 102 as a reference image.

Exemplarily, the application may display an image shared by any user in response to an operation of the user 101, and provide the entrance to the follow shooting function to the user in response to a selection operation (for example, a long press operation, a double-click operation, etc.) of the user 101 on the image. In response to the click operation of the user 101 on the entrance to the follow shooting function, the image displayed by the application is taken as the reference image.

After the reference image is determined, it may be determined that the image acquisition operation based on the reference image is detected. For example, the application may display the image acquisition page in response to this operation, and display the angle auxiliary frame in the image acquisition page to explicitly prompt a user of a current posture of the image acquisition device 102.

For example, after detecting the image acquisition operation based on the reference image, the image acquisition device may determine, based on the reference image, a reference shooting angle at which the image acquisition device may capture an image with the same shooting effect as the reference image. In the image acquisition process, the pose of the angle auxiliary frame may be adjusted in response to a rotation of the image acquisition device. For example, if the image acquisition device rotates to the reference shooting angle, the center point of the angle auxiliary frame may coincide with the center point of the image acquisition page. In this way, the user 101 may perceive that the posture adjustment of the image acquisition device 102 is in place, and control the image acquisition device to acquire an image within the field of view of the image acquisition device. For example, an initial pose of the angle auxiliary frame matches a shooting angle of the image acquisition device when the image acquisition operation based on the reference image is detected, or the initial pose of the angle auxiliary frame may be a pose of the angle auxiliary frame when the image acquisition device is at the reference shooting angle. After the angle auxiliary frame is displayed with the initial pose, the pose of the angle auxiliary frame is adjusted according to a real-time shooting angle of the image acquisition device. For example, when the shooting angle of the image acquisition device is not the reference shooting angle when the image acquisition operation based on the reference image is detected, a process of adjusting the pose of the angle auxiliary frame from the initial pose to a pose that matches the shooting angle of the image acquisition device when the image acquisition operation based on the reference image is detected takes a short time, and this process may be imperceptible to the user.

For example, the application installed on the image acquisition device 102 may also display, in the image acquisition page, the first prompt information other than the angle auxiliary frame in response to the rotation of the image acquisition device 102, and the first prompt information is used to prompt a rotation direction to provide guidance for rotating the image acquisition device 102 to the reference shooting angle to the user 101, so that efficiency and precision of the posture adjustment of the image acquisition device 102 may be improved.

It may be understood that the image acquisition method provided by at least one embodiment of the present disclosure may be applied to an image acquisition scenario, for example, to guide the user to adjust the posture of the image acquisition device 102 when the user uses the follow shooting function, so as to facilitate the user to acquire an image with a shooting effect approaching that of the reference image.

For example, the image acquisition method provided by at least one embodiment of the present disclosure may be implemented by software, hardware, firmware, or any combination thereof. For example, the image acquisition method provided by at least one embodiment of the present disclosure is applicable to the image acquisition device 102, and the image acquisition device 102 may load and execute the image acquisition method, which is not limited in the embodiments of the present disclosure. For example, the image acquisition device may include a central processing unit (Central Processing Unit, CPU) or a graphics processing unit (Graphics Processing Unit, GPU), a digital signal processor (DSP), and other forms of processing units with data processing capability and/or instruction execution capability, storage units, etc. An operating system, an application programming interface (e.g., OpenGL (Open Graphics Library), Metal, etc.) are also installed on the computing apparatus, etc., and the image acquisition method provided by the embodiments of the present disclosure is implemented by running codes or instructions. For example, the computing apparatus may also include an output component such as a display component, and the display component is, for example, a liquid crystal display (Liquid Crystal Display, LCD), an organic light emitting diode (Organic Light Emitting Diode, OLED) display, a quantum dot light emitting diode (Quantum Dot Light Emitting Diode, QLED) display, etc., which is not limited in the embodiments of the present disclosure. For example, the display component may display the angle auxiliary frame and the first prompt information, and may display the acquired image after the image acquisition device acquires the image within the field of view.

FIG. 2 is a schematic flowchart of an image acquisition method provided by at least one embodiment of the present disclosure.

As shown in FIG. 2, the image acquisition method 200 of this embodiment includes steps S210 to S230.

In step S210, displaying an angle auxiliary frame in an image acquisition page of an image acquisition device in response to an image acquisition operation based on a reference image.

In step S220, adjusting a pose of the angle auxiliary frame in response to a rotation of the image acquisition device, and displaying first prompt information in a region other than a display region of the angle auxiliary frame in the image acquisition page.

In step S230, acquiring an image within a field of view of the image acquisition device in response to an operation of determining to acquire the image.

Exemplarily, the image acquisition operation based on the reference image at least includes the click operation on the entrance to the follow shooting function mentioned above, and the click operation may be a single-click operation, a double-click operation, a long press operation, etc., which is not limited to the embodiments of the present disclosure. According to actual needs, the image acquisition operation based on the reference image may further include an operation of selecting the reference image, etc., and the entrance to the follow shooting function may be provided by a functional control, etc., which is not limited in the embodiments of the present disclosure.

Exemplarily, the angle auxiliary frame may be a frame of any shape, such as a square frame, a round frame, or a rounded frame, and the pose of the angle auxiliary frame may be adjusted with the rotation of the image acquisition device. For example, the pose of the angle auxiliary frame includes a position and a posture of the angle auxiliary frame. During the rotation of the image acquisition device, at least one of the position or the posture of the angle auxiliary frame is adjusted, so that the pose of the angle auxiliary frame may reflect a shooting angle of the image acquisition device. The shooting angle of the image acquisition device may be represented by at least one of a pitch angle, a yaw angle, and a roll angle of the image acquisition device, for example. For example, according to actual needs, the shooting angle of the image acquisition device may be represented by the pitch angle and/or the roll angle (the horizontal angle is also used hereinafter). The pitch angle may be, for example, an angle between the image acquisition device (specifically, an optical axis of a camera in the image acquisition device) and a ground plane, and the horizontal angle may be, for example, an angle between the image acquisition device and a vertical plane perpendicular to the ground plane.

For example, an area of the angle auxiliary frame may be a predetermined proportion of an area of a target region in the image acquisition page. The target region is a region for displaying an image within the field of view of the image acquisition device. For example, the angle auxiliary frame may be a rectangular frame, a width of the angle auxiliary frame may be a predetermined proportion of a width of the target region, and a height of the angle auxiliary frame may be a predetermined proportion of the width of the target region. The predetermined proportion may be ¼, ⅓, ½, etc., which is not limited in the embodiments of the present disclosure.

In the image acquisition process, a size of the angle auxiliary frame may be determined according to a format (e.g., camera format, the size of the image sensor or film used in a camera) of the image acquisition device. The real-time format of the image acquisition device may be monitored, so that the size of the angle auxiliary frame is maintained at a predetermined proportion of the real-time format. The real-time format may be a format after the format is simulated to change by, for example, zooming, switching cameras, or changing a shooting mode.

For example, if the shooting angle of the image acquisition device is represented by the pitch angle, a display position of the angle auxiliary frame in the image acquisition page may be adjusted, or a display height of the angle auxiliary frame in the image acquisition page may be adjusted in a case where it is determined that the pitch angle of the image acquisition device changes in response to the rotation of the image acquisition device. For example, a degree of change in the pitch angle of the image acquisition device corresponds to a degree of adjustment of the pose of the angle auxiliary frame, so that the rotation of the image acquisition device is explicitly reflected according to the adjustment of the pose of the angle auxiliary frame.

For example, if the shooting angle of the image acquisition device is represented by the horizontal angle, a display angle of the angle auxiliary frame in the image acquisition page may be adjusted, or a display width of the angle auxiliary frame in the image acquisition page may be adjusted in a case where it is determined that the horizontal angle of the image acquisition device changes in response to the rotation of the image acquisition device. For example, a degree of change in the horizontal angle of the image acquisition device corresponds to the degree of adjustment of the pose of the angle auxiliary frame, so that the rotation of the image acquisition device is explicitly reflected according to the adjustment of the pose of the angle auxiliary frame.

Exemplarily, the adjustment of the pose of the angle auxiliary frame may be performed based on a pose (also referred to as a target pose herein) of the angle auxiliary frame when the image acquisition device is at the reference shooting angle. A change in the pose of the angle auxiliary frame after the adjustment relative to the target pose may reflect a change in the shooting angle of the image acquisition device relative to the reference shooting angle after the rotation.

Exemplarily, an adjustment direction of the pose of the angle auxiliary frame may also be determined according to the rotation direction of the image acquisition device, and an adjustment amount of the pose of the angle auxiliary frame may be determined according to a rotation angle of the image acquisition device. The change in the pose of the angle auxiliary frame may reflect a change in the shooting angle of the image acquisition device caused by the rotation of the image acquisition device.

Exemplarily, the first prompt information may prompt the rotation direction to guide the user to rotate the image acquisition device according to the rotation direction, so as to rotate the image acquisition device to the reference shooting angle. For example, the rotation direction prompted by the first prompt information is a direction in which the image acquisition device approaches the reference shooting angle. For example, the reference shooting angle may include at least one of a reference horizontal angle or a reference pitch angle. The reference shooting angle may be indicated by the reference image; for example, the reference shooting angle may be a shooting angle at which the reference image is acquired by an acquisition device of the reference image. For example, the reference shooting angle may be represented by at least one of a reference pitch angle, a reference horizontal angle, and a reference yaw angle. A representation of the reference shooting angle is similar to that of the shooting angle of the image acquisition device, for example, the reference shooting angle may be represented by the reference pitch angle and/or the reference horizontal angle. For example, the first prompt information may include at least one of text information, pattern information, and video information, which is not limited in the embodiments of the present disclosure.

For example, a complete camera calibration method based on a single image may be used to determine the reference shooting angle indicated by the reference image, and a principle of determining the reference shooting angle is not limited in the embodiments of the present disclosure.

Exemplarily, a shooting determination control may be displayed in the image acquisition page, and the image acquisition device may acquire the image within the field of view of the image acquisition device in response to an operation on the shooting determination control. For example, the user may operate the shooting determination control at any time after the image acquisition device displays the image acquisition page, and the operation may include a click operation, etc., which is not limited in the embodiments of the present disclosure. For example, according to a preset result, an operation of clicking any position in the image acquisition page may also be taken as the operation of determining to acquire the image, so as to implement a “touch screen” shooting function.

Exemplarily, in a case where it is determined that a duration for which the image acquisition device maintains the reference shooting angle reaches a predetermined duration, the operation of determining to acquire the image may be automatically triggered by the image acquisition device, and the image within the field of view of the image acquisition device is acquired. In this way, an automatic shooting function may be realized, which may reduce the operations of the user in the image acquisition process, and is favorable for improving the image acquisition experience. For example, that the image acquisition device maintains the reference shooting angle may be understood as that the image acquisition device precisely maintains the reference shooting angle. For example, that the image acquisition device maintains the reference shooting angle may also be understood as that a difference between the shooting angle of the image acquisition device and the reference shooting angle is maintained within a predetermined difference, so as to ignore a jitter of the image acquisition device in the image acquisition process and improve the image acquisition efficiency.

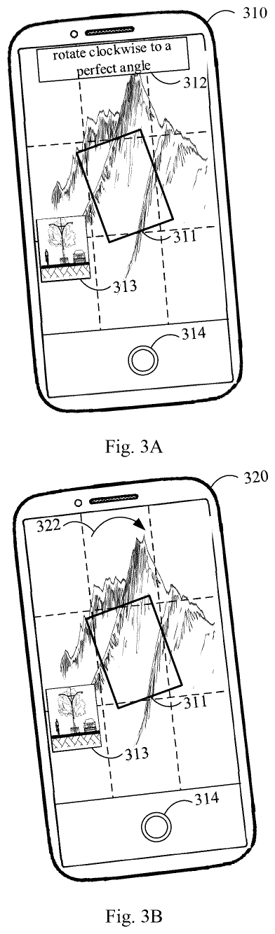

The display effect of the image acquisition page in the rotation process of the image acquisition device is described below as an example in conjunction with FIG. 3A and FIG. 3B.

FIG. 3A is a schematic diagram of an image acquisition page provided by at least one embodiment of the present disclosure, and FIG. 3B is a schematic diagram of an image acquisition page provided by at least another embodiment of the present disclosure.

Exemplarily, in the rotation process of the image acquisition device, the image acquisition page may be a page 310 as shown in FIG. 3A, or may be a page 320 as shown in FIG. 3B. In the image acquisition page, an angle auxiliary frame 311 is displayed, and the pose of the angle auxiliary frame 311 may reflect the shooting angle of the image acquisition device.

For example, the first prompt information may also be displayed in the image acquisition page, and the information types of the first prompt information may be different in different embodiments. For example, if the image acquisition device rotates counterclockwise relative to the reference shooting angle in a plane where the image acquisition device is located (i.e., taking an optical axis of the image acquisition device as a rotation axis), the first prompt information may be text information 312 in the page 310, for example, “rotate clockwise to a perfect angle”, etc.; or the first prompt information may be an arrow pattern 322 in the page 320, for example, a pattern of an arc arrow indicating clockwise rotation, etc. It should be understood that the above first prompt information is only an example to facilitate the understanding of the present disclosure, and is not limited in the embodiments of the present disclosure.

Exemplarily, as shown in FIG. 3A and FIG. 3B, a thumbnail 313 of the reference image may also be displayed in the image acquisition page, so as to facilitate the user to view the reference image.

Exemplarily, as shown in FIG. 3A and FIG. 3B, a shooting determination control 314 may also be displayed in the image acquisition page. The user may perform a click operation, etc., on the shooting determination control 314, and the image acquisition device may take the click operation, etc., as the operation of determining to acquire the image, and acquire the image within the field of view of the image acquisition device.

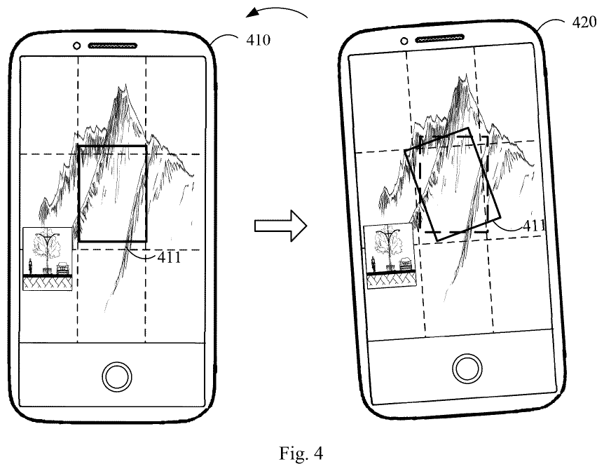

FIG. 4 is a schematic diagram of an effect of adjusting a pose of an angle auxiliary frame provided by at least one embodiment of the present disclosure.

According to the embodiments of the present disclosure, in an image acquisition process, the image acquisition device may be rotated by taking an optical axis of the image acquisition device as a rotation axis, so that an object in an image acquired by the image acquisition device is more upright, and the acquired image is more artistic. Accordingly, the rotation of the image acquisition device may include a first rotation by taking the optical axis of the image acquisition device as a first rotation axis. The optical axis of the image acquisition device may be understood as an optical axis of a camera included in the image acquisition device, that is, an axis that is led out from an optical center of the camera and is perpendicular to a lens in the camera.

As shown in FIG. 4, in response to the first rotation of the image acquisition device around the first rotation axis, the angle auxiliary frame may rotate with the first rotation by taking a reference center point of the angle auxiliary frame as a rotation center.

Exemplarily, before the image acquisition device rotates, an image acquisition page is a page 410, and a pose of an angle auxiliary frame 411 is a pose displayed on the page 410. In response to the image acquisition device rotating around the first rotation axis in an arrow direction (for example, a counterclockwise direction relative to a user) as shown in FIG. 4, the image acquisition page may be updated to a page 420, and the angle auxiliary frame 411 rotates counterclockwise to a pose in the page 420 by taking the reference center point as the rotation center.

For example, the reference center point may be a center point of the angle auxiliary frame 411, any vertex of the angle auxiliary frame, or any point in the image acquisition page, which is not limited in the embodiments of the present disclosure.

For example, in response to the first rotation of the image acquisition device, a rotation angle of the angle auxiliary frame 411 may be positively correlated with a rotation angle of the first rotation of the image acquisition device, so that the adjustment of the pose of the angle auxiliary frame 411 may better reflect the rotation of the image acquisition device.

Exemplarily, when adjusting the pose of the angle auxiliary frame in response to the first rotation of the image acquisition device, a rotation direction and a rotation angle of the first rotation may be first determined. For example, a horizontal angle of the image acquisition device may be periodically obtained, and the rotation direction and the rotation angle of the first rotation may be determined according to a difference between a horizontal angle before the first rotation and a real-time horizontal angle during the first rotation. After the rotation direction and the rotation angle are determined, the angle auxiliary frame may be controlled to rotate along the determined rotation direction. For example, the rotation angle of the angle auxiliary frame is positively correlated with the determined rotation angle of the first rotation.

Exemplarily, in response to the first rotation of the image acquisition device, the angle auxiliary frame may be rotated, by taking the reference center point as the rotation center, along a first rotation direction to a specified angle relative to a target pose. As mentioned above, the target pose is the pose of the angle auxiliary frame when the shooting angle of the image acquisition device is the reference shooting angle. The specified angle may be, for example, an angle by which the angle auxiliary frame 411 in a right diagram in FIG. 4 rotates relative to a dotted frame. The specified angle is determined, for example, according to a difference between the horizontal angle of the image acquisition device during the first rotation and a reference horizontal angle. The reference horizontal angle is a horizontal angle when the shooting angle of the image acquisition device is the reference shooting angle. For example, an angle value of the specified angle may be positively correlated with the difference between the horizontal angle of the image acquisition device and the reference horizontal angle.

In this embodiment, the angle auxiliary frame is rotated along the rotation direction of the image acquisition device in response to the rotation of the image acquisition device around the optical axis, so that the pose of the angle auxiliary frame may explicitly reflect the real-time shooting angle of the image acquisition device, and real-time and more accurate reference information may be provided for the user to adjust the shooting angle of the image acquisition device.

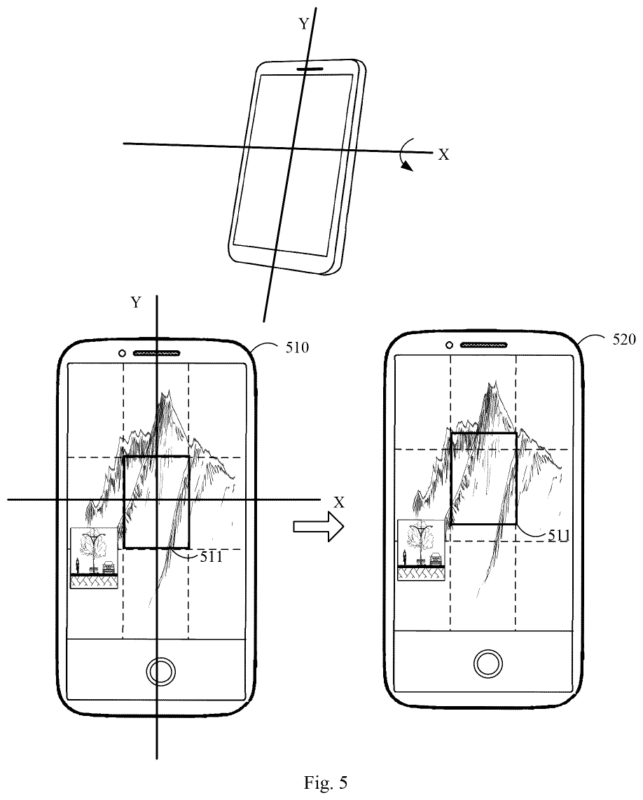

FIG. 5 is a schematic diagram of an effect of adjusting a pose of an angle auxiliary frame provided by at least another embodiment of the present disclosure.

According to the embodiments of the present disclosure, in an image acquisition process, the image acquisition device may be rotated by taking a symmetry axis of the image acquisition device as a rotation axis, so as to adjust a pitch angle or a yaw angle of the image acquisition device, and make the acquired image more artistic. Accordingly, the rotation of the image acquisition device may include a second rotation by taking the symmetry axis of the image acquisition device as a rotation axis.

For example, the second rotation may include a rotation by taking a symmetry axis (also referred to as a first symmetry axis herein) in a width direction of the image acquisition device as the rotation axis. For example, the symmetry axis in the width direction may be an axis parallel to an X axis shown in an upper diagram in FIG. 5, and the symmetry axis in the width direction may divide the image acquisition device into upper and lower parts. It should be understood that, according to actual needs, the second rotation may also include a rotation by taking a symmetry axis (also referred to as a second symmetry axis herein) in a height direction of the image acquisition device as the rotation axis. The symmetry axis in the height direction may be an axis parallel to a Y axis shown in the upper diagram in FIG. 5. For example, the second symmetry axis and the first symmetry axis are two symmetry axes perpendicular to each other.

As shown in FIG. 5, in response to the second rotation of the image acquisition device by taking the first symmetry axis as a second rotation axis, the angle auxiliary frame may move in an image acquisition page following the second rotation along the second symmetry axis of the image acquisition device.

Exemplarily, before the image acquisition device rotates, an image acquisition page is page 510, and a pose of an angle auxiliary frame is a pose displayed on page 510. In response to the image acquisition device rotating around the first symmetry axis in an arrow direction shown in an upper diagram in FIG. 5, the image acquisition page may be updated to a page 520, and an angle auxiliary frame 511 moves to a pose in the page 520 along a target pointing direction in a direction where the second symmetry axis is located.

For example, if the rotation direction of the second rotation is the arrow direction shown in the upper diagram in FIG. 5, that is, the second rotation increases a degree of looking up (e.g., upward viewing angle) of the image acquisition device, the target pointing direction may be an upward pointing direction in the direction where the second symmetry axis is located. If the rotation direction of the second rotation is opposite to the arrow direction shown in the upper diagram in FIG. 5, that is, the second rotation increases a degree of looking down (e.g., downward viewing angle) of the image acquisition device, the target pointing direction may be a downward pointing direction in the direction where the second symmetry axis is located. For example, the downward pointing direction and the upward pointing direction are also downward and upward pointing directions relative to the user.

Exemplarily, when adjusting the pose of the angle auxiliary frame in response to the second rotation of the image acquisition device around the first symmetry axis, a rotation direction and a rotation angle of the second rotation may be first determined. For example, the pitch angle of the image acquisition device may be periodically obtained, and the rotation direction and the rotation angle of the second rotation may be determined according to a difference between a pitch angle before the second rotation and a real-time pitch angle during the second rotation. After the rotation direction and the rotation angle are determined, the angle auxiliary frame may be controlled to move along the target pointing direction corresponding to the determined rotation direction. For example, the moving distance of the angle auxiliary frame is positively correlated with the determined rotation angle of the second rotation.

Exemplarily, in response to the second rotation of the image acquisition device around the first symmetry axis, the angle auxiliary frame 511 may move, along the target pointing direction in the direction where the second symmetry axis is located, to a specified position relative to a target pose. For example, the specified position may be understood as a relative position of the adjusted pose of the angle auxiliary frame 511 relative to the target pose in the direction where the second symmetry axis is located. The specified position is determined, for example, according to a difference between the pitch angle of the image acquisition device during the second rotation and a reference pitch angle. The reference pitch angle is a pitch angle when the shooting angle of the image acquisition device is the reference shooting angle. For example, a distance between a position of the specified position in the direction where the second symmetry axis is located and a position of the target pose in the direction where the second symmetry axis is located may be positively correlated with the difference between the pitch angle of the image acquisition device and the reference pitch angle.

For example, according to actual needs, the second rotation may also include a rotation of the image acquisition device by taking the second symmetry axis as the rotation axis. In this embodiment, in response to the second rotation, the angle auxiliary frame may move in the image acquisition page with the second rotation along the first symmetry axis. A moving direction of the angle auxiliary frame (which may also be referred to as the target pointing direction) may correspond to the rotation direction of the second rotation of the image acquisition device. For example, if the image acquisition device rotates clockwise relative to the user, the moving direction of the angle auxiliary frame may be a rightward pointing direction in the direction where the first symmetry axis is located (which is also a rightward pointing direction relative to the user). If the image acquisition device rotates counterclockwise relative to the user, the moving direction of the angle auxiliary frame may be a leftward pointing direction in the direction where the first symmetry axis is located (which is also a leftward pointing direction relative to the user).

In this embodiment, the angle auxiliary frame is moved in the image acquisition page along another symmetry axis perpendicular to the symmetry axis around which the image acquisition device rotates in response to the rotation of the image acquisition device around the symmetry axis of the image acquisition device, so that the pose of the angle auxiliary frame may explicitly reflect the real-time shooting angle of the image acquisition device, and real-time and more accurate reference information may be provided for the user to adjust the shooting angle of the image acquisition device.

For example, at least one of the pitch angle or the horizontal angle of the image acquisition device may be determined according to real-time data collected by a positioning device such as a gyroscope integrated in the image acquisition device, which is not limited in the embodiments of the present disclosure.

According to the embodiments of the present disclosure, at least one of the reference pitch angle or the reference horizontal angle may be indicated by the reference image, for example, may be determined based on the reference image. The principle of determining the reference pitch angle is described below by taking an example in which the reference pitch angle is determined based on the reference image and the reference horizontal angle is a specified angle value, such as zero degree. It should be understood that in a case where other reference angles included in the reference shooting angle, such as the reference horizontal angle, are determined based on the reference image, the principle of determining the other reference angles is similar to the principle of determining the reference pitch angle based on the reference image.

For example, when determining the reference pitch angle, an extrinsic parameter of an acquisition device that acquires the reference image, may be first determined based on the reference image. Then, the pitch angle of the acquisition device that acquires the reference image is determined based on the extrinsic parameter, and the determined pitch angle is taken as the reference pitch angle.

Exemplarily, any camera calibration method based on a single image may be used to calibrate the acquisition device that acquires the reference image, based on the reference image, to obtain a calibration result. The reference pitch angle is determined according to a rotation matrix included in the extrinsic parameter of the acquisition device in the calibration result. The extrinsic parameter of the acquisition device includes, for example, a rotation matrix and a displacement matrix, and through the rotation matrix and the displacement matrix, a point in a world coordinate system may be transformed to a camera coordinate system (i.e., a coordinate system established based on the acquisition device). It should be understood that, for example, the calibration result may also include an intrinsic parameter of the acquisition device, and the intrinsic parameter may include, for example, an parameter matrix and a distortion coefficient. Through the internal intrinsic of the acquisition device, a point in the camera coordinate system may be transformed to an image coordinate system (e.g., a coordinate system established based on the reference image).

Exemplarily, a deep learning model may be combined to calibrate the acquisition device that acquires the reference image. For example, the deep learning model may be first used to determine a perspective attribute of the reference image to obtain a first perspective attribute. Then, with an objective of minimizing a difference between the first perspective attribute and a second perspective attribute of the reference image represented by a camera model, the calibration result of the acquisition device that acquires the reference image is determined.

For example, the perspective attribute of the reference image may include at least: a projection of a vertical upward direction vector (i.e., a direction opposite to a gravity direction) on a two-dimensional image, and an angle between a line between a pixel in the image and an optical center of the acquisition device and a horizon. For example, the reference image may be input into the deep learning model, and the perspective attribute of each pixel in the reference image is output by the deep learning model. The camera model may be, for example, a pinhole camera model, and the perspective attribute represented by the pinhole camera model may be represented by the following formula, for example. uₚ represents the projection of the vertical upward direction vector on the two-dimensional image. φₚ represents the angle between the line between the pixel p in the image and the optical center of the acquisition device and the horizon. P represents a world coordinate corresponding to the pixel p, g represents a gravity vector, Π represents the camera model, n represents a direction vector from the optical center of the acquisition device to the pixel p, and t represents an adjustment coefficient.

$${u}_{p} = {lim}_{t \to 0} \frac{\prod ( P - tg ) - \prod ( P )}{{‖ \prod ( P - tg ) - \prod ( P ) ‖}_{2}} \qquad {φ}_{p} = arcsin ( \frac{{n}^{T} g}{{‖ n ‖}_{2}} )$$

For example, the camera model of the acquisition device may be solved by an iterative optimization method, so that an error between the perspective attribute derived based on the camera model and the perspective attribute predicted by the deep learning model is minimized. Then, the gravity direction may be determined based on the projection of the vertical upward direction vector represented by the solved camera model on the two-dimensional image, and the pitch angle of the acquisition device that acquires the reference image may be calculated from the gravity direction. For the calculation principle, reference may be made to, for example, the principle of calculating an Euler angle from gravity, which will not be described in detail herein.

For example, the deep learning model may employ a pixel-to-pixel network, which may include an encoder and a decoder corresponding to each perspective attribute. It should be understood that the above deep learning model is only an example to facilitate the understanding of the present disclosure, and is not limited in the embodiments of the present disclosure. According to actual needs, any deep learning model that may predict the perspective attribute from a single image may be used.

For example, after obtaining the perspective attribute using the deep learning model, a convolutional network may be used to process the perspective attribute, and a parameter of the acquisition device is output by the convolutional network, where the parameter may include, for example, the pitch angle, the roll angle, etc.

It should be understood that the above method for determining the pitch angle at which the acquisition device acquires the reference image is only an example to facilitate the understanding of the present disclosure, and is not limited in the embodiments of the present disclosure.

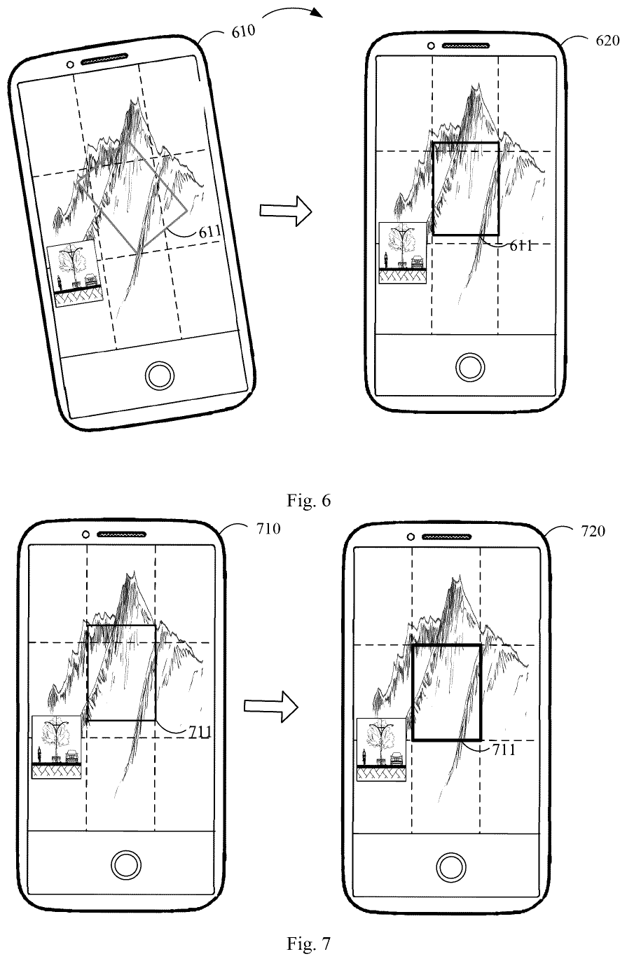

FIG. 6 is a schematic diagram of a change in a display state of an angle auxiliary frame in a process of an image acquisition device rotating to a reference posture provided by at least one embodiment of the present disclosure. FIG. 7 is a schematic diagram of a change in a display state of an angle auxiliary frame in a process of an image acquisition device rotating to a reference posture provided by at least another embodiment of the present disclosure.

According to the embodiments of the present disclosure, in the process of the image acquisition device rotating to the reference shooting angle, the display state of the angle auxiliary frame may be updated from a non-highlighted state to a highlighted state, so as to more prominently prompt the user that the image acquisition device is about to or has already rotated to a perfect angle, and an image with a shooting effect approaching that of the reference image may be acquired.

For example, in the rotation process of the image acquisition device, in response to a difference between the shooting angle of the image acquisition device and the reference shooting angle being less than a predetermined difference, the display state of the angle auxiliary frame may be updated from the non-highlighted state to the highlighted state, rather than being updated to the highlighted state only when the shooting angle of the image acquisition device coincides with the reference shooting angle. In this way, it may be avoided that it is difficult for the shooting angle of the image acquisition device to coincide with the reference shooting angle due to a jitter, so that the user cannot be prompted for a long time that the image acquisition device has rotated to the perfect angle, resulting in a poor user experience.

For example, as shown in FIG. 6, in a process of the image acquisition device rotating from a posture shown in a left diagram in FIG. 6 to a posture shown in a right diagram in FIG. 6, an angle auxiliary frame 611 may be adjusted from a posture in a page 610 shown in the left diagram in FIG. 6 to a posture in a page 620 shown in the right diagram in FIG. 6. For example, when the angle auxiliary frame 611 is adjusted to the posture in the page 620, an outer frame of the angle auxiliary frame 611 may be displayed in bold as compared with an outer frame of the angle auxiliary frame in the page 610, or a color of the outer frame may be updated to a color with higher saturation, to highlight the angle auxiliary frame 611.

Exemplarily, if a parameter representing the posture of the image acquisition device includes the horizontal angle of the image acquisition device, and a parameter representing the reference posture includes the reference horizontal angle, in this embodiment, in a case where a difference between the horizontal angle of the image acquisition device and the reference horizontal angle is less than a first predetermined difference, a first display parameter of the angle auxiliary frame may be adjusted, and a value of the first display parameter is updated from a first value to a second value. For example, the first display parameter may include a display color, a line width, etc. Taking the first display parameter including the display color as an example, the first value may be, for example, an RGB value representing yellow, and the second value may be, for example, an RGB value representing green. Alternatively, as shown in FIG. 6, the first value may be, for example, an RGB value representing gray, and the second value may be, for example, an RGB value representing black. For example, the first predetermined difference may be set according to actual needs, and may be, for example, 5°, 3°, etc. It should be understood that the value of the above first predetermined difference is only an example to facilitate the understanding of the present disclosure, and is not limited in the embodiments of the present disclosure.

For example, as shown in FIG. 7, in a process of the image acquisition device rotating from a posture shown in a left diagram in FIG. 7 to a reference posture shown in a right diagram in FIG. 7, an angle auxiliary frame 711 may be adjusted from a posture in a page 710 shown in the left diagram in FIG. 7 to a posture in a page 720 shown in the right diagram in FIG. 7. For example, when the angle auxiliary frame 711 is adjusted to the posture in the page 720, an outer frame of the angle auxiliary frame 711 may be displayed in bold as compared with an outer frame of the angle auxiliary frame in the page 710, or a color of the outer frame may be updated to a color with higher saturation, so as to highlight the angle auxiliary frame 711.

Exemplarily, if the posture of the image acquisition device is represented by the horizontal angle and the pitch angle, and the reference posture is represented by the reference horizontal angle and the reference pitch angle, in this embodiment, in a case where the difference between the horizontal angle of the image acquisition device and the reference horizontal angle is less than the first predetermined difference, and a difference between the pitch angle of the image acquisition device and the reference pitch angle is less than a second predetermined difference, a second display parameter of the angle auxiliary frame may be adjusted, and a value of the second display parameter is updated from a third value to a fourth value. For example, the second display parameter may include a display color, a line width, etc. Taking the second display parameter including the line width as an example, as shown in FIG. 7, the first value may be, for example, 0.5 pt (point, a pixel unit), and the second value may be, for example, 1 pt. For example, the first predetermined difference and the second predetermined difference may be the same or different, and the values of the two predetermined differences may be set according to actual needs, for example, the first predetermined difference and the second predetermined difference may both be 5°, etc. It should be understood that the values of the above first predetermined difference and second predetermined difference are only examples to facilitate the understanding of the present disclosure, and are not limited in the embodiments of the present disclosure.

According to the embodiments of the present disclosure, in the process of the image acquisition device rotating to the reference shooting angle, the change in the display state may include both the change shown in FIG. 6 and the change shown in FIG. 7. For example, the aforementioned first display parameter and the second display parameter are different parameters, so as to reflect both the change shown in FIG. 6 and the change shown in FIG. 7 through the adjustment of the display parameters.

According to the embodiments of the present disclosure, in a case where the difference between the shooting angle of the image acquisition device and the reference shooting angle is less than the predetermined difference, the user may also be reminded by making the image acquisition device vibrate that the image acquisition device is about to or has already rotated to the perfect angle, and an image with a shooting effect approaching that of the reference image may be acquired. Compared with the highlighted manner, the vibration manner may give the user a reminder tactilely, and the reminder effect is more obvious.

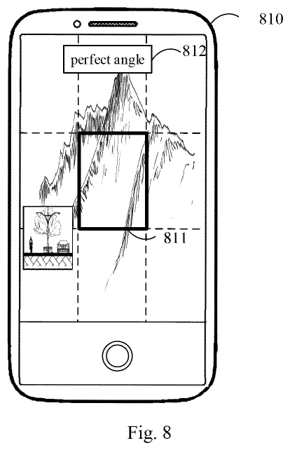

FIG. 8 is a schematic diagram of an image acquisition page provided by at least one embodiment of the present disclosure in a case where an image acquisition device rotates to a reference shooting angle.

According to the embodiments of the present disclosure, in the case where the difference between the shooting angle of the image acquisition device and the reference shooting angle is less than the predetermined difference, the user may also be reminded by displaying additional prompt information that the image acquisition device is about to or has already rotated to the perfect angle, and an image with a shooting effect approaching that of the reference image may be acquired.

As shown in FIG. 8, in the case where the difference between the shooting angle of the image acquisition device and the reference shooting angle is less than the predetermined difference, not only an angle auxiliary frame 811 displayed in an image acquisition page 810, but also second prompt information 812 may be displayed. For example, the second prompt information 812 may be text information such as “perfect angle”, or “perfect angle, start taking photos”, or may be any form of information used to prompt that the image acquisition device satisfies an image acquisition condition, which is not limited in the embodiments of the present disclosure.

For example, the second prompt information 812 may be displayed at the display position of the first prompt information mentioned above. That is, in response to the difference between the shooting angle of the image acquisition device and the reference shooting angle being less than the predetermined difference, the first prompt information displayed in the rotation process of the image acquisition device may be updated to the second prompt information 812.

For example, in this embodiment, a display state of the angle auxiliary frame 811 in the image acquisition page 810 may be a highlighted state or a non-highlighted state, which is not limited in the embodiments of the present disclosure.

By displaying the second prompt information, the embodiments of the present disclosure may more explicitly prompt the user that the image acquisition device is about to or has already rotated to the perfect angle, and an image with a shooting effect approaching that of the reference image may be acquired.

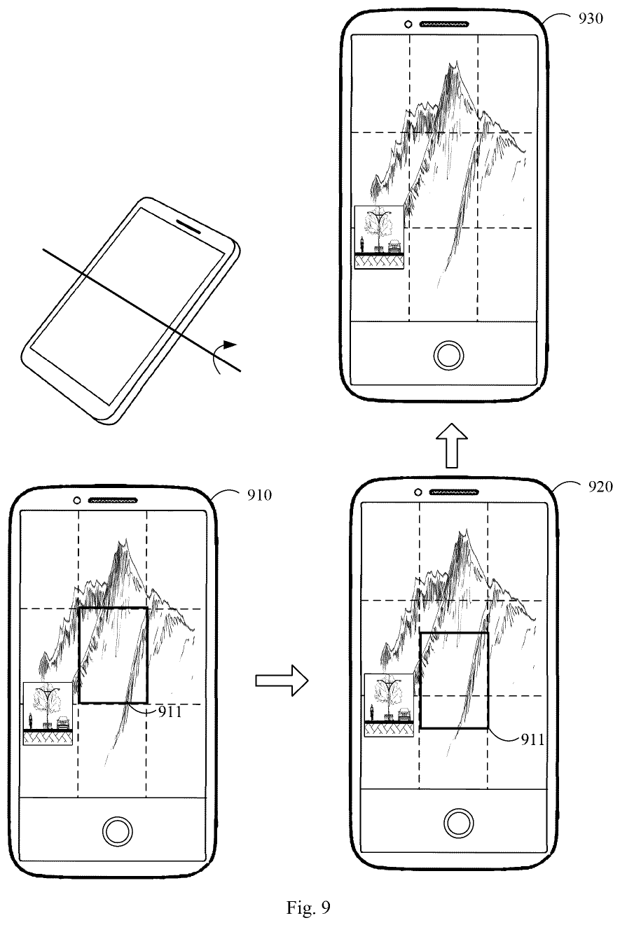

FIG. 9 is a schematic diagram of a change in the display state of an angle auxiliary frame in a process of an image acquisition device rotating in a direction away from a reference posture provided by at least one embodiment of the present disclosure.

According to the embodiments of the present disclosure, in the process of the image acquisition device rotating in the direction away from the reference shooting angle, the angle auxiliary frame may be switched from a displayed state to a hidden state to prompt the user that the current posture of the image acquisition device deviates too much from the reference posture, and in this way, for example, an effect of reminding the user to readjust the posture of the image acquisition device from an initial posture may be achieved.

For example, as shown in FIG. 9, in a process of the image acquisition device taking a posture shown in a lower left diagram in FIG. 9 as the initial posture, taking a symmetry axis shown in an upper left diagram in FIG. 9 as a rotation axis, and rotating in an arrow direction shown in the upper left diagram in FIG. 9 in the direction away from the reference shooting angle, a posture of an angle auxiliary frame 911 may be first gradually adjusted from a posture shown in a page 910 to a posture shown in a page 920. That is, in the rotation process of the image acquisition device, the angle auxiliary frame 911 moves downward relative to the user along another symmetry axis of the image acquisition device that is perpendicular to the rotation axis, thereby moving to the posture shown in page 920. In a case where the image acquisition device continues to rotate in the arrow direction, and a difference between the posture of the image acquisition device and the reference posture is greater than a target difference, the page 920 may be updated to a page 930, and in the page 930, the angle auxiliary frame is no longer displayed. The case where the difference between the posture of the image acquisition device and the reference posture is greater than the target difference may be, for example, that a difference between a pitch angle of the image acquisition device and a reference pitch angle is greater than a third predetermined difference. The third predetermined difference may be, for example, a value set according to actual needs, such as 30°, which is not limited in the embodiments of the present disclosure.

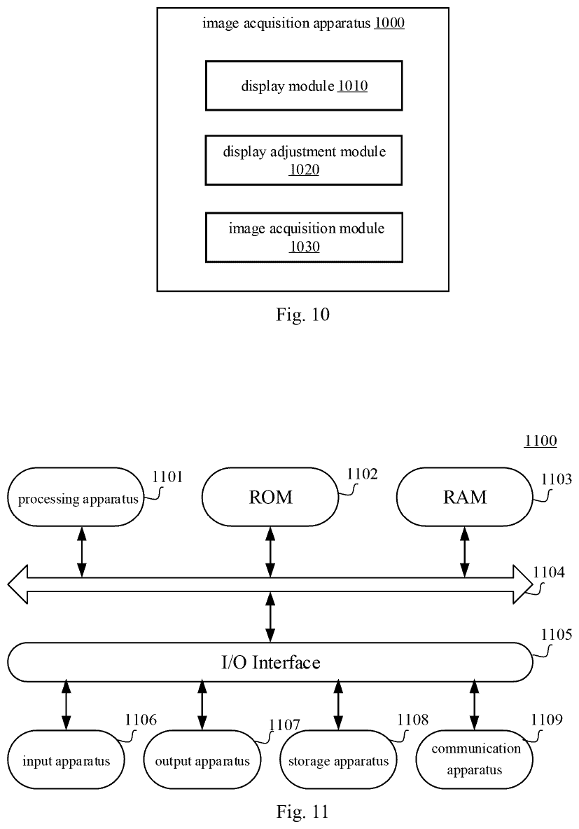

Based on the image acquisition method provided by at least one embodiment of the present disclosure, at least one embodiment of the present disclosure further provides an image acquisition apparatus. The image acquisition apparatus will be described in detail below with reference to FIG. 10.

FIG. 10 is a schematic block diagram of an image acquisition apparatus provided by at least one embodiment of the present disclosure.

As shown in FIG. 10, the image acquisition apparatus 1000 of this embodiment includes a display module 1010, a display adjustment module 1020, and an image acquisition module 1030. For example, these units or modules may be implemented by hardware (e.g., circuit) modules or software modules, etc., which is the same as the embodiments below and will not be repeated. For example, these units or modules may be implemented by a central processing unit (CPU), a general-purpose graphics processing unit (GPGPU), a graphics processing unit (GPU), a tensor processing unit (TPU), a field programmable logic gate array (FPGA), or other forms of processing units with data processing capability and/or instruction execution capability, and corresponding computer instructions.

The display module 1010 is configured to display an angle auxiliary frame in an image acquisition page of an image acquisition device in response to an image acquisition operation based on a reference image. Exemplarily, the display module 1010 may be configured to perform step S210 described above, and for a specific implementation principle of the display module 1010, reference may be made to the relevant description of step S210, which will not be repeated herein.

The display adjustment module 1020 is configured to adjust a pose of the angle auxiliary frame in response to a rotation of the image acquisition device, and display first prompt information in a region other than a display region of the angle auxiliary frame in the image acquisition page. For example, adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image. Exemplarily, the display adjustment module 1020 may be configured to perform step S220 described above, and for a specific implementation principle of the display adjustment module 1020, reference may be made to the relevant description of step S220, which will not be repeated herein.

The image acquisition module 1030 is configured to acquire an image within a field of view of the image acquisition device in response to an operation of determining to acquire the image. Exemplarily, the image acquisition module 1030 may be configured to perform step S230 described above, and for a specific implementation principle of the image acquisition module 1030, reference may be made to the relevant description of step S230, which will not be repeated herein.

In at least one embodiment of the present disclosure, the display adjustment module 1020 may be further configured to: in response to a second rotation of the image acquisition device by taking a first symmetry axis of the image acquisition device as a second rotation axis, move the angle auxiliary frame in the image acquisition page along a second symmetry axis of the image acquisition device with the second rotation, where the second symmetry axis is perpendicular to the first symmetry axis.

In at least one embodiment of the present disclosure, the reference shooting angle includes a reference pitch angle. The display adjustment module 1020 may be configured to: in response to the second rotation of the image acquisition device, move the angle auxiliary frame, along a target pointing direction in a direction where the second symmetry axis is located, to a specified position relative to a target pose, where the target pose is a pose of the angle auxiliary frame when the image acquisition device rotates to the reference shooting angle, the specified position is determined according to a difference between a pitch angle of the image acquisition device and the reference pitch angle, and the target pointing direction is determined according to a rotation direction of the second rotation relative to the reference shooting angle.

In at least one embodiment of the present disclosure, the display adjustment module 1020 may be further configured to: in response to a first rotation of the image acquisition device by taking an optical axis of the image acquisition device as a first rotation axis, rotate the angle auxiliary frame with the first rotation by taking a reference center point of the angle auxiliary frame as a rotation center.

In at least one embodiment of the present disclosure, the reference shooting angle includes a reference horizontal angle. The display adjustment module 1020 may be configured to: in response to the first rotation of the image acquisition device, rotate the angle auxiliary frame, with the reference center point as the rotation center, along a first rotation direction to a specified angle relative to a target pose, where the first rotation direction is a rotation direction of the first rotation relative to the reference shooting angle, the target pose is a pose of the angle auxiliary frame when the image acquisition device rotates to the reference shooting angle, and the specified angle is determined according to a difference between the horizontal angle of the image acquisition device and the reference horizontal angle.

In at least one embodiment of the present disclosure, the reference shooting angle includes a reference pitch angle. The reference pitch angle is determined by: determining, based on the reference image, an extrinsic parameter of an acquisition device that acquires the reference image; and determining, based on the extrinsic parameter, a pitch angle of the acquisition device that acquires the reference image as the reference pitch angle.

In at least one embodiment of the present disclosure, the determining, based on the reference image, an extrinsic parameter of an acquisition device that acquires the reference image includes: determining a perspective attribute of the reference image by using a predetermined deep learning model to obtain a first perspective attribute; and determining a calibration result of the acquisition device that acquires the reference image with an objective of minimizing a difference between the first perspective attribute and a second perspective attribute of the reference image represented by a camera model, where the calibration result includes the extrinsic parameter of the acquisition device that acquires the reference image.

In at least one embodiment of the present disclosure, the display adjustment module 1020 may be further configured to: update a display state of the angle auxiliary frame from a non-highlighted state to a highlighted state in a process of the image acquisition device rotating to the reference shooting angle.

In at least one embodiment of the present disclosure, the display adjustment module 1020 may be further configured to: update the display state of the angle auxiliary frame from the non-highlighted state to the highlighted state in response to a difference between the shooting angle of the image acquisition device and the reference shooting angle being less than a predetermined difference.

In at least one embodiment of the present disclosure, the display adjustment module 1020 may be further configured to: change a first display parameter of the angle auxiliary frame in response to a difference between the horizontal angle of the image acquisition device and the reference horizontal angle being less than a second predetermined difference; and change at least one second display parameter of the angle auxiliary frame in response to a difference between a pitch angle of the image acquisition device and the reference pitch angle being less than a first predetermined difference and the difference between the horizontal angle of the image acquisition device and the reference horizontal angle being less than the second predetermined difference, where at least part of the at least one second display parameter is different from the first display parameter.

In at least one embodiment of the present disclosure, the display adjustment module 1020 may be further configured to: update the first prompt information to second prompt information in response to the difference between a shooting angle of the image acquisition device and the reference shooting angle being less than the predetermined difference, where the second prompt information is used to prompt that the image acquisition device satisfies an image acquisition condition.

In at least one embodiment of the present disclosure, the display adjustment module 1020 may be further configured to: hide the angle auxiliary frame in a process of the image acquisition device rotating in a direction away from the reference shooting angle by taking the first symmetry axis of the image acquisition device as a second rotation axis.

In at least one embodiment of the present disclosure, the image acquisition module 1030 may be further configured to: acquire the image within the field of view of the image acquisition device in response to a duration that the difference between the shooting angle of the image acquisition device and the reference shooting angle is less than the predetermined difference being greater than a predetermined duration.

It should be noted that, for clarity and conciseness of representation, not all the constituent units of the image acquisition apparatus 1000 are given in the embodiments of the present disclosure. To achieve the necessary functions of the image acquisition apparatus 1000, those skilled in the art may provide and set other constituent units not shown according to specific needs, which is not limited in the embodiments of the present disclosure.

At least one embodiment of the present disclosure further provides an electronic device, including: a processing apparatus; and a storage apparatus, including one or more computer program modules; where the one or more computer program modules are stored in the storage apparatus and configured to be executed by the processing apparatus, and the one or more computer program modules are used to implement the image acquisition method provided by any of the embodiments of the present disclosure.

For example, the processing apparatus may be a central processing unit (CPU), a digital signal processor (DSP), a graphics processing unit (GPU), a general-purpose graphics processing unit (GPGPU) or other forms of processing units with data processing capability and/or instruction execution capability, may be a general-purpose processor or a dedicated processor, and may control other components in the electronic device to perform desired functions.

For example, the storage apparatus may include one or more computer program products, which may include various forms of computer-readable storage media, such as volatile memory and/or non-volatile memory. The volatile memory may include, for example, a random access memory (RAM) and/or a cache memory (cache). The non-volatile memory may include, for example, a read-only memory (ROM), a hard disk, a flash memory, etc. One or more computer program instructions may be stored on the computer-readable storage medium, and the processing apparatus may run the program instructions to implement the functions (implemented by the processing apparatus) in the embodiments of the present disclosure and/or other desired functions, such as the image acquisition method. Various applications and various data may also be stored in the computer-readable storage medium, such as the reference shooting angle, the pitch angle, and the horizontal angle before the image acquisition device rotates, and various data used and/or generated by the applications.

Reference is made to FIG. 11 below, which illustrates a schematic structural diagram of an electronic device (e.g., a terminal device or a server) 1100 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle-mounted navigation terminal), and fixed terminals such as a digital TV and a desktop computer. The electronic device shown in FIG. 11 is only an example, and should not impose any limitation on the functions and the range of use of the embodiments of the present disclosure.

As shown in FIG. 11, the electronic device 1100 may include a processing apparatus (e.g., a central processing unit, a graphics processing unit, etc.) 1101, which may perform various appropriate actions and processing according to a program stored in a read-only memory (ROM) 1102 or a program loaded from a storage apparatus 1108 into a random access memory (RAM) 1103. In the RAM 1103, various programs and data required for the operations of the electronic device 1100 are also stored. The processing apparatus 1101, the ROM 1102, and the RAM 1103 are connected to each other through a bus 1104. An input/output (I/O) interface 1105 is also connected to the bus 1104.

Usually, the following apparatuses may be connected to the I/O interface 1105: an input apparatus 1106 including, for example, a touch screen, a touchpad, a keyboard, a mouse, a camera, a microphone, an accelerometer, and a gyroscope; an output apparatus 1107 including, for example, a liquid crystal display (LCD), a speaker, and a vibrator; the storage apparatus 1108 including, for example, a magnetic tape and a hard disk; and a communication apparatus 1109. The communication apparatus 1109 may allow the electronic device 1100 to perform wireless or wired communication with other devices to exchange data. Although FIG. 11 shows the electronic device 1100 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program codes for executing the method shown in the flowchart. In such an embodiment, the computer program may be downloaded and installed from a network through the communication apparatus 1109, or installed from the storage apparatus 1108, or installed from the ROM 1102. When the computer program is executed by the processing apparatus 1101, the functions defined in the method of the embodiments of the present disclosure are executed.

It should be noted that the computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus, device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program codes are carried therein. This propagated data signal may take many forms, including but not limited to electromagnetic signals, optical signals, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program codes contained on the computer-readable medium may be transmitted by any suitable medium, including but not limited to wires, optical cables, radio frequency (RF), etc., or any suitable combination of the above.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs, which, when executed by the electronic device, cause the electronic device to: display an angle auxiliary frame in an image acquisition page of an image acquisition device in response to an image acquisition operation based on a reference image; adjust a pose of the angle auxiliary frame in response to a rotation of the image acquisition device, and display first prompt information in a region other than a display region of the angle auxiliary frame in the image acquisition page; where adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image; and acquire an image within a field of view of the image acquisition device in response to an operation of determining to acquire the image.

Alternatively, the computer-readable medium carries one or more programs, which, when executed by the electronic device, cause the electronic device to: display an angle auxiliary frame in an image acquisition page of an image acquisition device in response to an image acquisition operation based on a reference image; adjust a pose of the angle auxiliary frame in response to a rotation of the image acquisition device, and display first prompt information in a region other than a display region of the angle auxiliary frame in the image acquisition page; where adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image; and acquire an image within a field of view of the image acquisition device in response to an operation of determining to acquire the image.

The computer program codes for executing the operations of the present disclosure may be written in one or more programming languages or a combination thereof, where the programming languages include, but are not limited to, object-oriented programming languages such as Java, Smalltalk, and C++, and may also include conventional procedural programming languages such as “C” language or similar programming languages. The program codes may be executed entirely on a computer of a user, partly on the computer of the user, as a stand-alone software package, partly on the computer of the user and partly on a remote computer, or entirely on the remote computer or a server. In the case of involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, a program segment, or a part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units or modules involved in the embodiments of the present disclosure may be implemented by software or by hardware. The name of the unit or module does not constitute a limitation on the unit or module itself under certain circumstances.

The functions described above may be performed at least in part by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, the machine-readable medium may be a tangible medium that may contain or store programs for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides an image acquisition method, including:
displaying an angle auxiliary frame in an image acquisition page of an image acquisition device in response to an image acquisition operation based on a reference image;
adjusting a pose of the angle auxiliary frame in response to a rotation of the image acquisition device, and displaying first prompt information in a region other than a display region of the angle auxiliary frame in the image acquisition page; where adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image; and
acquiring an image within a field of view of the image acquisition device in response to an operation of determining to acquire the image.

According to one or more embodiments of the present disclosure, Example 2 provides that adjusting the pose of the angle auxiliary frame in Example 1 includes:

in response to a second rotation of the image acquisition device by taking a first symmetry axis of the image acquisition device as a second rotation axis, the angle auxiliary frame moving following the second rotation along a second symmetry axis of the image acquisition device within the image acquisition page, wherein the second symmetry axis is perpendicular to the first symmetry axis.

According to one or more embodiments of the present disclosure, Example 3 provides that the reference shooting angle in Example 2 includes a reference pitch angle; and the angle auxiliary frame in Example 2 moves following the second rotation along the second symmetry axis of the image acquisition device in the image acquisition page, including:
in response to the second rotation of the image acquisition device, the angle auxiliary frame moving, along a target pointing direction in a direction where the second symmetry axis is located, to a specified position relative to a target pose,
where the target pose is a pose of the angle auxiliary frame when the image acquisition device rotates to the reference shooting angle, the specified position is determined according to a difference between a pitch angle of the image acquisition device and the reference pitch angle, and the target pointing direction is determined according to a rotation direction of the second rotation relative to the reference shooting angle.

According to one or more embodiments of the present disclosure, Example 4 provides that adjusting the pose of the angle auxiliary frame in any one of Example 1 to Example 3 includes:
in response to a first rotation of the image acquisition device by taking an optical axis of the image acquisition device as a first rotation axis, the angle auxiliary frame rotating following the first rotation by taking a reference center point of the angle auxiliary frame as a rotation center.

According to one or more embodiments of the present disclosure, Example 5 provides that the reference shooting angle in Example 4 includes a reference horizontal angle; and the angle auxiliary frame in Example 4 rotates following the first rotation by taking the reference center point of the angle auxiliary frame as the rotation center, including:
in response to the first rotation of the image acquisition device, the angle auxiliary frame rotating, with the reference center point as the rotation center, along a first rotation direction to a specified angle relative to a target pose,
where the first rotation direction is a rotation direction of the first rotation relative to the reference shooting angle, the target pose is a pose of the angle auxiliary frame when the image acquisition device rotates to the reference shooting angle, and the specified angle is determined according to a difference between the horizontal angle of the image acquisition device and the reference horizontal angle.

According to one or more embodiments of the present disclosure, Example 6 provides that the reference shooting angle in any one of Example 1 to Example 3 includes a reference pitch angle, and the reference pitch angle is determined by:
determining, based on the reference image, an extrinsic parameter of an acquisition device that acquires the reference image; and
determining, based on the extrinsic parameter, a pitch angle of the acquisition device that acquires the reference image as the reference pitch angle.

According to one or more embodiments of the present disclosure, Example 7 provides that the determining, based on the reference image, an extrinsic parameter of an acquisition device that acquires the reference image in Example 6 includes:
determining a perspective attribute of the reference image by using a predetermined deep learning model to obtain a first perspective attribute; and
determining a calibration result of the acquisition device that acquires the reference image with an objective of minimizing a difference between the first perspective attribute and a second perspective attribute of the reference image represented by a camera model,
where the calibration result includes the extrinsic parameter of the acquisition device that acquires the reference image.

According to one or more embodiments of the present disclosure, Example 8 provides the image acquisition method in Example 1, further including:
updating a display state of the angle auxiliary frame from a non-highlighted state to a highlighted state in a process of the image acquisition device rotating to a reference posture.

According to one or more embodiments of the present disclosure, Example 9 provides that updating a display state of the angle auxiliary frame in Example 8 from a non-highlighted state to a highlighted state, including:
updating the display state of the angle auxiliary frame from the non-highlighted state to the highlighted state in response to a difference between the shooting angle of the image acquisition device and the reference shooting angle being less than a predetermined difference.

According to one or more embodiments of the present disclosure, Example 10 provides that the reference shooting angle in Example 9 includes a reference pitch angle and a reference horizontal angle; and the display state of the angle auxiliary frame is updated from the non-highlighted state to the highlighted state in response to the difference between the shooting angle of the image acquisition device and the reference shooting angle being less than the predetermined difference in Example 9, including at least one of:
changing a first display parameter of the angle auxiliary frame in response to a difference between the horizontal angle of the image acquisition device and the reference horizontal angle being less than a second predetermined difference; and
changing at least one second display parameter of the angle auxiliary frame in response to a difference between a pitch angle of the image acquisition device and the reference pitch angle being less than a first predetermined difference and the difference between the horizontal angle of the image acquisition device and the reference horizontal angle being less than the second predetermined difference, wherein at least part of the at least one second display parameter is different from the first display parameter.

According to one or more embodiments of the present disclosure, Example 11 provides the image acquisition method in Example 1, further including:
updating the first prompt information to second prompt information in response to a difference between a shooting angle of the image acquisition device and the reference shooting angle being less than a predetermined difference,
where the second prompt information is used to prompt that the image acquisition device satisfies an image acquisition condition.

According to one or more embodiments of the present disclosure, Example 12 provides the image acquisition method in Example 1, further including:
hiding the angle auxiliary frame in a process of the image acquisition device rotating, in a direction away from the reference shooting angle, by taking a first symmetry axis of the image acquisition device as a second rotation axis.

According to one or more embodiments of the present disclosure, Example 13 provides that the acquiring an image within a field of view of the image acquisition device in response to determining an image acquisition operation in Example 1 includes:
acquiring the image within the field of view of the image acquisition device in response to a duration in which a difference between the shooting angle of the image acquisition device and the reference shooting angle is less than a predetermined difference being greater than a predetermined duration.

According to one or more embodiments of the present disclosure, Example 14 provides that the first prompt information in Example 1 includes at least one of the following information: text information and an arrow pattern.

According to one or more embodiments of the present disclosure, Example 15 provides an image acquisition apparatus, including:
a display module, configured to display an angle auxiliary frame in an image acquisition page of an image acquisition device in response to an image acquisition operation based on a reference image;
a display adjustment module, configured to adjust a pose of the angle auxiliary frame in response to a rotation of the image acquisition device, and display first prompt information in a region other than a display region of the angle auxiliary frame in the image acquisition page; where adjusting the pose of the angle auxiliary frame includes adjusting at least one of a position or a posture of the angle auxiliary frame, and the first prompt information is used to prompt a rotation direction to guide the image acquisition device to rotate to a reference shooting angle indicated by the reference image; and
an image acquisition module, configured to acquire an image within a field of view of the image acquisition device in response to determining an operation of determining to acquire the image.

According to one or more embodiments of the present disclosure, Example 16 provides an electronic device, including:
a processing apparatus; and
a storage apparatus, including one or more computer program instructions;
where the one or more computer program instructions, when executed by the processing apparatus, implement the image acquisition method provided by at least one embodiment of the present disclosure.

According to one or more embodiments of the present disclosure, Example 17 provides a computer-readable storage medium, non-transiently storing computer-readable instructions, where the computer-readable instructions, when executed by a processor, implement the image acquisition method provided by at least one embodiment of the present disclosure.

According to one or more embodiments of the present disclosure, Example 18 provides a computer program product, including a computer program/instructions, which, when running on a computer, causes the computer to execute the image acquisition method provided by at least one embodiment of the present disclosure.

The above description is only preferred embodiments of the present disclosure and an explanation of the applied technical principles. Those skilled in the art should understand that the disclosure scope involved in the present disclosure is not limited to the technical solutions formed by the specific combination of the above technical features, and should also cover other technical solutions formed by any combination of the above technical features or their equivalent features without departing from the above disclosure concept. For example, a technical solution formed by replacing the above features with technical features with similar functions disclosed in the present disclosure (but not limited thereto) also falls within the protection scope of the present disclosure.

In addition, although the operations are depicted in a specific order, this should not be understood as requiring the operations to be performed in the specific order shown or in a sequential order. Under certain circumstances, multitasking and parallel processing may be beneficial. Similarly, although the above discussion contains a number of specific implementation details, these should not be interpreted as limiting the scope of the present disclosure. Certain features that are described in the context of separate embodiments may also be implemented in combination in a single embodiment. On the contrary, various features described in the context of a single embodiment may also be implemented in multiple embodiments individually or in any suitable sub-combination.

Although the subject matter has been described in terms specific to the structural features and/or method logic actions, it should be understood that the subject matter defined in the appended claims is not necessarily limited to the specific features or actions described above. On the contrary, the specific features and actions described above are only exemplary forms of implementing the claims.

1. An image acquisition method, comprising:
displaying an angle auxiliary frame in an image acquisition page of an image acquisition device in response to an image acquisition operation based on a reference image;
adjusting a pose of the angle auxiliary frame in response to a rotation of the image acquisition device, and displaying first prompt information in a region other than a display region of the angle auxiliary frame in the image acquisition page, wherein the adjusting the pose of the angle auxiliary frame comprises adjusting at least one of a position or a posture of the angle auxiliary frame, and the first prompt information is used to prompt a rotation direction to guide the image acquisition device to rotate to a reference shooting angle indicated by the reference image; and
acquiring an image within a field of view of the image acquisition device in response to an operation of determining to acquire the image.

2. The method of claim 1, wherein the adjusting the pose of the angle auxiliary frame comprises:
in response to a second rotation of the image acquisition device by taking a first symmetry axis of the image acquisition device as a second rotation axis, the angle auxiliary frame moving following the second rotation along a second symmetry axis of the image acquisition device within the image acquisition page, wherein the second symmetry axis is perpendicular to the first symmetry axis.

3. The method of claim 2, wherein the reference shooting angle comprises a reference pitch angle;
the angle auxiliary frame moving following the second rotation along a second symmetry axis of the image acquisition device within the image acquisition page, comprises:
in response to the second rotation of the image acquisition device, the angle auxiliary frame moving, along a target pointing direction in a direction where the second symmetry axis is located, to a specified position relative to a target pose,
wherein, the target pose is a pose of the angle auxiliary frame when the image acquisition device rotates to the reference shooting angle, the specified position is determined according to a difference between a pitch angle of the image acquisition device and the reference pitch angle; and the target pointing direction is determined according to a rotation direction of the second rotation relative to the reference shooting angle.

4. The method of claim 1, wherein the adjusting the pose of the angle auxiliary frame comprises:
in response to a first rotation of the image acquisition device by taking an optical axis of the image acquisition device as a first rotation axis, the angle auxiliary frame rotating following the first rotation by taking a reference center point of the angle auxiliary frame as a rotation center.

5. The method of claim 4, wherein, the reference shooting angle comprises a reference horizontal angle;
the angle auxiliary frame rotating following the first rotation by taking a reference center point of the angle auxiliary frame as a rotation center, comprises:
in response to the first rotation of the image acquisition device, the angle auxiliary frame rotating, with the reference center point as the rotation center, along a first rotation direction to a specified angle relative to a target pose,
wherein, the first rotation direction is a rotation direction of the first rotation relative to the reference shooting angle, the target pose is a pose of the angle auxiliary frame when the image acquisition device rotates to the reference shooting angle, and the specified angle is determined according to a difference between a horizontal angle of the image acquisition device and the reference horizontal angle.

6. The method of claim 1, wherein, the reference shooting angle comprises a reference pitch angle;
wherein, the reference pitch angle is determined by:
determining, based on the reference image, an extrinsic parameter of an acquisition device that acquires the reference image; and
determining, based on the extrinsic parameter, a pitch angle of the acquisition device that acquires the reference image as the reference pitch angle.

7. The method of claim 6, wherein, the determining, based on the reference image, an extrinsic parameter of an acquisition device that acquires the reference image comprises:
determining a perspective attribute of the reference image by using a predetermined deep learning model to obtain a first perspective attribute; and
determining a calibration result of the acquisition device that acquires the reference image with an objective of minimizing a difference between the first perspective attribute and a second perspective attribute of the reference image represented by a camera model,
wherein the calibration result comprises the extrinsic parameter of the acquisition device that acquires the reference image.

8. The method of claim 1, further comprising:
updating a display state of the angle auxiliary frame from a non-highlighted state to a highlighted state in a process of the image acquisition device rotating to the reference shooting angle.

9. The method of claim 8, wherein, the updating a display state of the angle auxiliary frame from a non-highlighted state to a highlighted state, comprising:
updating the display state of the angle auxiliary frame from the non-highlighted state to the highlighted state in response to a difference between a shooting angle of the image acquisition device and the reference shooting angle being less than a predetermined difference.

10. The method of claim 9, wherein, the reference shooting angle comprises a reference pitch angle and a reference horizontal angle;
the updating the display state of the angle auxiliary frame from the non-highlighted state to the highlighted state in response to the difference between the shooting angle of the image acquisition device and the reference shooting angle being less than the predetermined difference, comprises at least one of:
changing a first display parameter of the angle auxiliary frame in response to a difference between a horizontal angle of the image acquisition device and the reference horizontal angle being less than a second predetermined difference; and
changing at least one second display parameter of the angle auxiliary frame in response to a difference between a pitch angle of the image acquisition device and the reference pitch angle being less than a first predetermined difference and the difference between the horizontal angle of the image acquisition device and the reference horizontal angle being less than the second predetermined difference, wherein at least part of the at least one second display parameter is different from the first display parameter.

11. The method of claim 1, further comprising:
updating the first prompt information to second prompt information in response to a difference between a shooting angle of the image acquisition device and the reference shooting angle being less than a predetermined difference,
wherein, the second prompt information is used to prompt that the image acquisition device satisfies an image acquisition condition.

12. The method of claim 1, further comprising:
hiding the angle auxiliary frame in a process of the image acquisition device rotating, in a direction away from the reference shooting angle, by taking a first symmetry axis of the image acquisition device as a second rotation axis.

13. The method of claim 1, wherein, the acquiring an image within a field of view of the image acquisition device in response to an operation of determining to acquire the image, comprises:
acquiring the image within the field of view of the image acquisition device in response to a duration in which a difference between the shooting angle of the image acquisition device and the reference shooting angle is less than a predetermined difference being greater than a predetermined duration.

14. The method of claim 1, wherein, the first prompt information comprises at least one of following information: text information and an arrow pattern.

15. An electronic device, comprising:
a processing apparatus; and
a storage apparatus, comprising one or more computer program instructions;
wherein, the one or more computer program instructions, when executed by the processing apparatus, implement an image acquisition method;
wherein the image acquisition method comprises:
displaying an angle auxiliary frame in an image acquisition page of an image acquisition device in response to an image acquisition operation based on a reference image;
adjusting a pose of the angle auxiliary frame in response to a rotation of the image acquisition device, and displaying first prompt information in a region other than a display region of the angle auxiliary frame in the image acquisition page, wherein, the adjusting the pose of the angle auxiliary frame comprises adjusting at least one of a position or a posture of the angle auxiliary frame, and the first prompt information is used to prompt a rotation direction to guide the image acquisition device to rotate to a reference shooting angle indicated by the reference image; and
acquiring an image within a field of view of the image acquisition device in response to an operation of determining to acquire the image.

16. The electronic device of claim 15, wherein the adjusting the pose of the angle auxiliary frame comprises:
in response to a second rotation of the image acquisition device by taking a first symmetry axis of the image acquisition device as a second rotation axis, the angle auxiliary frame moving following the second rotation along a second symmetry axis of the image acquisition device within the image acquisition page, wherein the second symmetry axis is perpendicular to the first symmetry axis.

17. The electronic device of claim 15, wherein the adjusting the pose of the angle auxiliary frame comprises:
in response to a first rotation of the image acquisition device by taking an optical axis of the image acquisition device as a first rotation axis, the angle auxiliary frame rotating following the first rotation by taking a reference center point of the angle auxiliary frame as a rotation center.

18. A non-transitory computer-readable storage medium, non-transiently storing computer-readable instructions, wherein, the computer-readable instructions, when executed by a processor, implement an image acquisition method;
wherein the image acquisition method comprises:
displaying an angle auxiliary frame in an image acquisition page of an image acquisition device in response to an image acquisition operation based on a reference image;
adjusting a pose of the angle auxiliary frame in response to a rotation of the image acquisition device, and displaying first prompt information in a region other than a display region of the angle auxiliary frame in the image acquisition page, wherein the adjusting the pose of the angle auxiliary frame comprises adjusting at least one of a position or a posture of the angle auxiliary frame, and the first prompt information is used to prompt a rotation direction to guide the image acquisition device to rotate to a reference shooting angle indicated by the reference image; and
acquiring an image within a field of view of the image acquisition device in response to an operation of determining to acquire the image.

19. The non-transitory computer-readable storage medium according to claim 18, wherein, the adjusting the pose of the angle auxiliary frame comprises:
in response to a second rotation of the image acquisition device by taking a first symmetry axis of the image acquisition device as a second rotation axis, the angle auxiliary frame moving following the second rotation along a second symmetry axis of the image acquisition device within the image acquisition page, wherein the second symmetry axis is perpendicular to the first symmetry axis.

20. The electronic device of claim 18, wherein, the adjusting the pose of the angle auxiliary frame comprises:
in response to a first rotation of the image acquisition device by taking an optical axis of the image acquisition device as a first rotation axis, the angle auxiliary frame rotating following the first rotation by taking a reference center point of the angle auxiliary frame as a rotation center.
